(19) United States
(12) Patent Application Publication
(10) Pub. No.: US 2006/0219601 A1
(43) Pub. Date: Oct. 5, 2006

(54) Method and system for digitally imaging and processing mail

(75) Inventors: Robert L. Babanats, Vestavia Hills, AL (US); Howard Craig Reeves, Birmingham, AL (US)

Correspondence Address: DARBY & DARBY P.C., P. O. BOX 5257, NEW YORK, NY, 10150-5257, US

(73) Assignee: Imaging Business Machines, LLC, Birmingham, AL (US)

(21) Appl. No.: 11/371,295

(22) Filed: Mar. 8, 2006

Related U.S. Application Data
(60) Provisional application No. 60/660,143, filed on Mar. 9, 2005.

(51) Int. Cl. B07C 5/02

(52) U.S. Cl. 209/3.3

(57) ABSTRACT

A method and system that allows organizations that deal with a substantial volume of incoming mail to digitally capture, organize, prioritize and deliver incoming mail to users more quickly and efficiently than with conventional approaches. In accordance with an exemplary embodiment, a unique tag is applied to each piece of incoming mail (including parcels). Each piece of mail is then processed, scanned, electronically delivered, and viewed. Relevant information relating to each piece of mail is extracted. The unique tag is used to track the corresponding piece of mail and its related information. Scanning each piece allows users to retrieve and view their mail from any location that allows access to the organization's network. By obtaining relevant information at various points of processing (e.g., from the envelope), the incoming mail can be monitored, released and processed in a controlled and intelligent manner.

### CROSS-REFERENCE TO RELATED APPLICATIONS

The present application claims benefit of provisional application Ser. No. 60/660,143 entitled “Method and System for Digitally Imaging and Processing Mail,” filed on Mar. 9, 2005, the benefit of the earlier filing date of which is hereby claimed under 35 U.S.C. § 119 (e) and 37 C.F.R. §1.78, and which is further incorporated by reference.

### FIELD OF THE INVENTION

The present invention relates to the processing of mail, particularly the automated processing of high-volume incoming mail.

### BACKGROUND INFORMATION

The processing of large volumes of incoming mail can be labor intensive, particularly where there is a large variety of incoming mail types and mail of different priorities. Some advances have been made in automating aspects of this process including sorting, opening, and scanning.

### SUMMARY OF THE INVENTION

One embodiment is a method of processing incoming mail including assigning an identification to a piece of incoming mail; obtaining information from an envelope of the piece of incoming mail; extracting a content of the piece of incoming mail; scanning the content; associating the identification, the information from the envelope, and the content; and routing the piece of incoming mail based on at least one of the information from the envelope or the content.

Another embodiment is a system for processing incoming mail. The system includes a tagging device configured and arranged to tag a piece of incoming mail with an identification tag; an information extracting device to receive the piece of incoming mail from the tagging device, the information extracting device comprising an imager to image an envelope of the piece of incoming mail; an extractor configured and arranged to open the incoming mail after the envelope has been scanned and extract the incoming mail's contents; a scanner configured and arranged to scan the contents; and a processor configured and arranged to associate the information tag, envelope information, and contents of the piece of incoming mail and to provide routing instructions for the piece of incoming mail.

These and other aspects of the present invention will be apparent from the following detailed description and drawings.

### BRIEF DESCRIPTION OF THE DRAWINGS

FIG. 1 is a flow diagram of an exemplary embodiment of a process in accordance with the present invention.

### DETAILED DESCRIPTION

The present invention provides methods and systems that allow organizations that deal with a substantial volume of incoming mail to digitally capture, organize, prioritize and deliver incoming mail to users more quickly and efficiently than with conventional approaches. In accordance with an exemplary embodiment, a unique tag is applied to each piece of incoming mail (including parcels). Each piece of mail is then processed, scanned, electronically delivered, and viewed. Any relevant information relating to each piece of mail is extracted at various points in the process. The unique tag is used to track the corresponding piece of mail and its related information.

Scanning each piece of mail allows users to retrieve and view their mail from any location that allows access to the organization's network.

In at least some embodiments, there is no need for separate streams of incoming mail. By extracting useful information from each piece of incoming mail at various points in the process (e.g., address information from the envelope), incoming mail is given a status that allows the flow and process of each piece to be monitored, released and processed in a controlled manner. For example, where the incoming mail may represent credits and debits (e.g., income tax payments or refund requests; or accounts receivable and payable), the processing of the incoming mail can be regulated to ensure that debits do not exceed credits or that there is a sufficient reserve to cover incoming debits. Moreover, demographic information can be derived (e.g., from originating zip codes) to provide some indication of the incoming mail (e.g., magnitude of tax payment or refund request; or amount of credit or debit.)

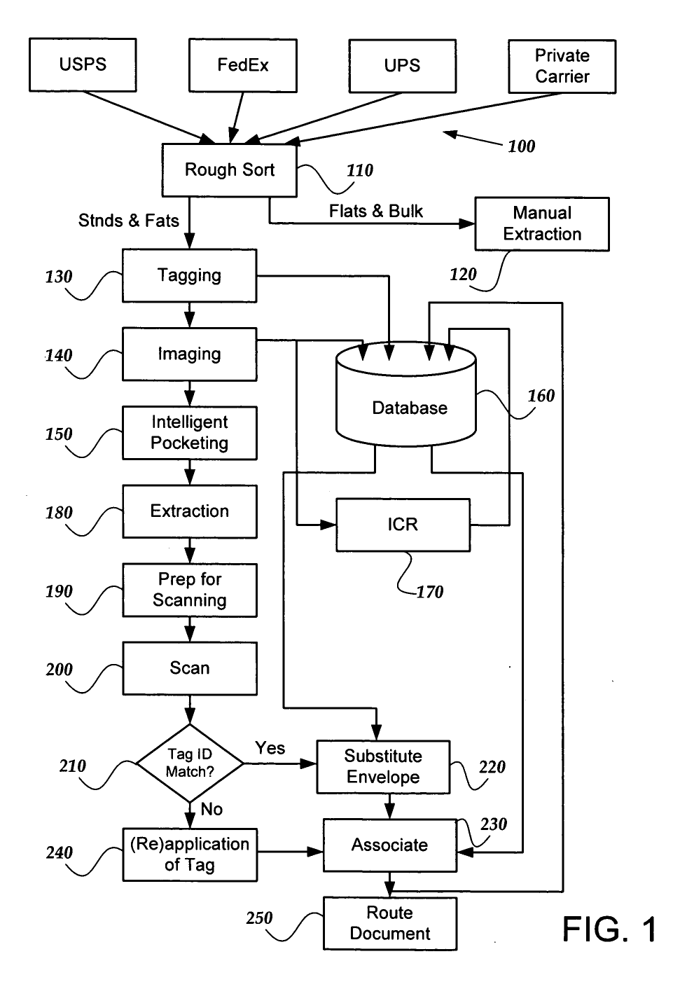

In one embodiment illustrated in FIG. 1, mail from one or more delivery services arrives at a processing facility (step 100). Such delivery services may include, for example, the US Postal Service, FedEx, UPS, private carriers, etc.

As mail arrives at the facility, a rough sort is preferably performed (step 110) to route incoming mail to an information extractor that is best suited for each type of mail. Such a rough sort can include sorting the incoming mail into one or more categories. Examples of categories include “flat” mail (e.g., catalogs, magazines, flyers), “bulk” mail (e.g., parcels), “standard” mail (e.g., letters in standard sized envelopes) and “fats” (e.g., non-flat envelopes). Other categorizations of incoming mail can be used. Rough sorting can be performed manually or automatically and may utilize any known sorting devices. In particular, commercial sorting devices are available to sort a variety of types of incoming mail.

Once the rough sort is complete, the groupings of mail are taken to the respective information extractor (step 120). At this step, the contents of the flats and bulk mail, for example, may be manually extracted from their external packaging (if any).

The standards and fats, which are in envelopes, are sent to a fine sort station that will determine the mail stop of the individual piece of mail. During the fine sort, a unique identifying tag is placed in a clear area of the envelope (step 130). The unique tag may include one or more of a 1D barcode, a 2D barcode, an RFID or any other suitable identifying device. Any type of tagging device can be used and such devices are commercially available for providing unique tags to individual items.

A tag may also be placed on each piece of bulk or flat mail as well. The tag that is placed on each envelope or package provides a unique identifier to each piece of mail received and allows tracking of each piece to begin automatically (step 140).

Once an identifying tag has been applied to a piece of mail, an image of the tagged piece of mail is taken to capture the condition of the piece before additional processing occurs. Any type of imaging device can be used. Preferably, the device provides a digital image.

Based on information obtained from the envelope (e.g., addressee, addressor, postage, postal codes, etc.), each piece of incoming mail can be optionally intelligently pocketed (or sorted) to a pre-defined location (“pocket” or sort end-point) (step 150). Examples of suitable equipment which may be used during this process include the MailCode Olympus II, Pitney Bowes M3, the Agissar APS and AMS series of machines, or the Opex MPS40, among others.

The tag identification and image for each piece of mail are stored in a database 160 and can be used for tracking, prioritizing, monitoring, reporting, and image replacement later in the lifecycle of the contents.

The original image of each envelope is processed through an Intelligent Character Recognition (ICR) engine 170 to automatically read the name and address of both the addressor and addressee, postmark information and/or any other printed text located on the front of the envelope. This information is stored in the aforementioned database and related to the original bar code. Any type of ICR engine can be used and a variety of such engines are available commercially.

Once the tagged piece of mail has been imaged, it is routed to an extraction station where the identifying tag is read and the contents are removed from the envelope (step 170). The contents and envelope are stacked for further processing. Examples of suitable equipment that can be used during the extraction process include the Opex Model 60, Opex Model 51, or the Agissar double and triple cut series Ultra extraction desk, among others.

If no intelligent data is gathered from the envelope or if the data gathered is inconsistent with expected data (e.g., the name of the addressee on the envelope does not match that of any person in the organization), the envelope is routed to a repair station for additional data entry and/or verification (not shown). This operation will typically be handled manually.

After extraction, the contents and their respective envelopes are prepared for scanning (step 190). The preparation function may include staple removal, taping of cuts or tears, paper clip removal, binder clip removal, document placement (ordering), insertion of header sheets, etc. The envelopes are placed in front of their respective contents and are used as document separators.

The envelopes and contents are then routed to a scanning station for scanning (step 200). During the scan operation, the envelopes are scanned for bar codes or other machine-readable indicia (e.g., RFIDs) that comprise the unique identification tag discussed above. The envelopes and contents are then imaged (front and rear, as needed) and may be sorted accordingly (e.g., as by an ImageTrac scanner). Any type of imaging or scanning device can be used and a variety of such devices are available commercially.

Any tag identification information gathered during the scan operation is compared to the tag identification data assigned during the sort/extraction process (step 210). If a match occurs, the image of the envelope that was captured before extraction is substituted for the empty envelope (step 220) and associated with the scanned contents of the envelope, the data obtained from the envelope (e.g., address), and the tag identification data (step 230). For example, any type of processor can be used to associate the relevant data. Suitable processors include those embodied by computers, servers, and the like.

If there is no match between the tag identification information gathered during the scan operation and the tag identification data assigned during the sort/extraction process, the piece of mail is returned for (re)application of an identifying tag and processed as described above (step 240).

The workflow rules of the organization will then determine the disposition of the transaction and route the contents and envelope. For standard mail, the scanned image of the envelope and contents can be routed electronically (e.g., by e-mail) to the intended recipient (step 250). A processor, such as a computer or server, can be used to route the mail electronically. Bulk or flat mail is routed physically to the intended recipient. As such, each piece of incoming mail is routed to the department, person or work processing group that has been assigned to handle that piece of mail.

Throughout the process of digitizing each piece of mail, all transactions whether manual or automatic may be recorded for tracking purposes. This maintains a consistent and accurate logging for process review.

The mail and operational work now may be reviewed or processed per the business rules established by each organization.

By extracting as much relevant information as possible from the envelope and contents of each piece of mail, the present invention allows each piece of mail to be quickly and accurately routed to the most appropriate recipient (person or department) for that piece of mail. Moreover, by scanning each piece of mail, an electronic record of each piece of mail is made which can be conveniently and rapidly distributed using conventional data communications means (e.g. e-mail). In addition, an electronic back-up is made should the original piece of mail be lost or discarded.

It is to be understood that while the invention has been described above in conjunction with preferred specific embodiments, the description is intended to illustrate and not to limit the scope of the invention, as defined by the appended claims. Indeed, various modifications of the invention in addition to those described herein will become apparent to those skilled in the art from the foregoing description and the accompanying figures. Such modifications are intended to fall within the scope of the appended claims.

It is further to be understood that all values are to some degree approximate, and are provided for purposes of description.

The disclosures of any patents, patent applications, and publications that may be cited throughout this application are incorporated herein by reference in their entireties.

What is claimed is:

1. A method of processing incoming mail comprising:
assigning an identification to a piece of incoming mail;
obtaining information from an envelope of the piece of incoming mail;
extracting a content of the piece of incoming mail;
scanning the content;
associating the identification, the information from the envelope, and the content; and
routing the piece of incoming mail based on at least one of the information from the envelope or the content.

2. The method of claim 1, further comprising sorting incoming mail.

3. The method of claim 2, wherein sorting incoming mail comprises sorting incoming mail into at least flat, bulk, and standard mail.

4. The method of claim 2, wherein sorting incoming mail comprises sorting incoming mail into at least flat, bulk, standard, and fat mail.

5. The method of claim 1, further comprising comparing the information from the envelope and the content to determine a match.

6. The method of claim 1, further comprising creating a database containing the identification.

7. The method of claim 6, wherein the database further comprises the information from the envelope.

8. The method of claim 7, wherein the database further comprises the content.

9. The method of claim 1, wherein obtaining information from the envelope comprises scanning the envelope.

10. The method of claim 9, wherein obtaining information from the envelope further comprises processing the envelope using character recognition.

11. The method of claim 1, wherein routing the piece of incoming mail comprises routing the piece of incoming mail in an electronic format.

12. A system for processing incoming mail, the system comprising:
a tagging device configured and arranged to tag a piece of incoming mail with an identification tag;
an information extracting device to receive the piece of incoming mail from the tagging device, the information extracting device comprising an imager to image an envelope of the piece of incoming mail;
an extractor configured and arranged to open the incoming mail after the envelope has been scanned and extract the incoming mail's contents;
a scanner configured and arranged to scan the contents; and
a processor configured and arranged to associate the information tag, envelope information, and contents of the piece of incoming mail and to provide routing instructions for the piece of incoming mail.

13. The system of claim 12, further comprising a database configured and arranged to receive the image of the envelope.

14. The system of claim 13, wherein the database is configured and arranged to receive the scanned contents of the piece of incoming mail.

15. The system of claim 12, further comprising a character recognition apparatus configured and arranged to scan the image of the envelope to obtain information from the envelope.

16. The system of claim 12, further comprising an intelligent pocketing apparatus to fine sort at least a portion of the incoming mail.

17. A system for processing incoming mail comprising:
means for assigning an identification to a piece of incoming mail;
means for obtaining information from an envelope of the piece of incoming mail;
means for extracting a content of the piece of incoming mail;
means for scanning the content;
means for associating the identification, the information from the envelope, and the content; and
means for routing the piece of incoming mail based on at least one of the information from the envelope or the content.

18. The system of claim 17, further comprising means for sorting incoming mail.

19. The system of claim 17, further comprising a database comprising the information from the envelope and the content of the piece of incoming mail.

20. The system of claim 17, further comprising means for processing the envelope using character recognition.
